(19) United States
(12) Patent Application Publication
(10) Pub. No.: US 2022/0236075 A1
(43) Pub. Date: Jul. 28, 2022

(54) MAP CONSTRUCTION DEVICE AND METHOD THEREOF

(71) Applicant: Coretronic Corporation, Hsin-Chu (TW)

(72) Inventors: Pin-Hsuan Ho, Hsin-Chu (TW); Yen-Yi Chen, Hsin-Chu (TW); Pei-Chi Hsiao, Hsin-Chu (TW)

(73) Assignee: Coretronic Corporation, Hsin-Chu (TW)

(21) Appl. No.: 17/567,899

(22) Filed: Jan. 4, 2022

(30) Foreign Application Priority Data
Jan. 28, 2021 (CN) 202110121167.3

(51) Int. Cl. G01C 21/00; G06N 3/08

(52) U.S. Cl. CPC G01C 21/3833; G06N 3/084; G01C 21/3881

(57) ABSTRACT

The embodiments of the present invention propose a map construction device and method thereof. According to the method, a three-dimensional map is obtained, the three-dimensional map is converted to an initial two-dimensional map, the occupancy probabilities of the grids on the initial two-dimensional map is determined by the training model, and a final two-dimensional map is generated according to the occupancy probabilities of the grid. The three-dimensional map is constructed based on the depth data generated the architectural space scanning. The initial two-dimensional map is divided into multiple grids. The occupancy probability of each grid is related to whether there is an object occupying thereon. The final two-dimensional map is divided according to the grids, and the grids on the final two-dimensional map are determined whether there are objects occupying thereon. Therefore, according to the map construction device and method of the disclosure, a high-precision two-dimensional map can be generated.

### CROSS-REFERENCE TO RELATED APPLICATION

This application claims the priority benefit of China application serial no. 202110121167.3, filed on Jan. 28, 2021. The entirety of the above-mentioned patent application is hereby incorporated by reference herein and made a part of this specification.

### BACKGROUND

### 1. Technical Field

The disclosure relates to a map drawing, and in particular relates to a map construction device and a method thereof.

### 2. Description of Related Art

With the rapid development of industrial automation, unmanned guided vehicles (or automatically guided vehicles (AGVs)) have become an important research and development project in intelligent logistics automation, and nowadays, unmanned guided vehicles have been used in scenarios such as factory handling, warehousing and logistics, medical equipment transportation, and automatic parking. Without manual guidance, the unmanned guided vehicle can solve the problem of repetitive tasks by automatically driving on an established route in an established map environment. Therefore, in order to achieve the aforementioned automatic navigation, it is very important to construct an accurate map of the environment.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a map construction device and a method thereof, in which machine learning algorithms are applied to an occupancy grid map, thereby improving the accuracy of obstacle location identification.

Other purposes and advantages of the disclosure may be further understood from the technology features disclosed in the disclosure.

In order to achieve one or part of all of the above-mentioned purposes or other purposes, the map construction method proposed by an embodiment of the disclosure includes (but is not limited to) the following steps: obtaining a three-dimensional map; converting the three-dimensional map to an initial two-dimensional map; determining occupancy probabilities of the multiple grids on the initial two-dimensional map through a training model; and generating a final two-dimensional map according to the occupancy probabilities of the multiple grids. The three-dimensional map is constructed based on depth data generated by scanning an architectural space. The initial two-dimensional map is divided into multiple grids. The occupancy probability of each of the multiple grids is related to whether there is an object occupying thereon. The final two-dimensional map is divided according to the multiple grids, and the multiple grids on the final two-dimensional map are determined whether there are objects occupying thereon. Thereby, an accurate two-dimensional map can be generated.

In order to achieve one or all of the above-mentioned parts or purposes or other purposes, a map construction device including (but not limited to) a memory and a processor is proposed by an embodiment of the disclosure. The memory is configured to store multiple software modules. The processor is coupled to the memory, and loads and performs the multiple software modules. The multiple software modules include a two-dimensional conversion module and a map construction module. The two-dimensional conversion module obtains a three-dimensional map and converts the three-dimensional map to an initial two-dimensional map. The three-dimensional map is constructed based on depth data generated by scanning an architectural space, and the initial two-dimensional map is divided into multiple grids. The map construction module determines occupancy probabilities of the multiple grids on the initial two-dimensional map through a training model, and generates the final two-dimensional map based on the occupancy probabilities of the multiple grids. The occupancy probability of each of the multiple grids is related to whether there is an object occupying thereon. The training model is constructed based on a machine learning algorithms. The final two-dimensional map is divided according to the multiple grids, and the multiple grids on the final two-dimensional map are determined whether there are objects occupying thereon.

Based on the above, according to the map construction device and method of the disclosure embodiment, the occupancy probabilities of the grids are determined through the training model, and the final two-dimensional map is generated accordingly. Thereby, the region having obstacles can be distinguished more accurately, and the planning of transportation tasks and logistics management can be facilitated.

Other objectives, features and advantages of the disclosure will be further understood from the further technological features disclosed by the embodiments of the disclosure where there are shown and described exemplary embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of the disclosure. The drawings illustrate embodiments of the disclosure and, together with the description, serve to explain the principles of the disclosure.

FIG. 1 is an element block diagram of a map construction device according to an embodiment of the disclosure.

FIG. 2 is a flow chart of a map construction method according to an embodiment of the disclosure.

FIG. 3 is a flow chart of map conversion according to an embodiment of the disclosure.

FIG. 4A is an example illustrating a three-dimensional map obtained by a distance sensing device.

FIG. 4B is another example illustrating a three-dimensional map obtained by a distance sensing device.

FIG. 5A is an example illustrating an initial two-dimensional map.

FIG. 5B is an example illustrating a schematic diagram of scanning obstacles.

FIG. 6 is a flow chart of generating a final two-dimensional map according to an embodiment of the disclosure.

FIG. 7 is a flow chart of updating a map based on object identification according to an embodiment of the disclosure.

FIG. 8A is an example illustrating segmenting an image of an object.

FIG. 8B is an example illustrating identifying an object and the orientation thereof.

FIG. 8C is an example illustrating an updated final two-dimensional map.

FIG. 9A is an example illustration a planar point cloud diagram by an unmanned vehicle with height direct projection.

FIG. 9B is an example illustrating a final two-dimensional map generated according to an embodiment of the disclosure.

FIG. 9C is an example illustrating the final two-dimensional map generated by taking a frame of the point cloud image scanned at each time as the training data.

FIG. 9D is an example illustrating a final two-dimensional map generated by taking a frame of point cloud image and global point cloud image scanned at each time as training data.

FIG. 9E is an example of a final two-dimensional map generated based on a binary cross entropy loss.

FIG. 9F is an example of a final two-dimensional map generated based on a binary focal loss.

### DESCRIPTION OF THE EMBODIMENTS

The aforementioned and other technology contents, features and effects of the disclosure will be clearly presented in the following detailed description of a preferred embodiment in conjunction with the accompanying drawings. The directional terms mentioned in the following embodiments, such as: up, down, left, right, front, or back are only directions with reference to the accompanying drawings. Therefore, the directional terms used are intended to illustrate and not to limit the disclosure. Furthermore, the term “coupling” referred to in the following embodiments may refer to any direct or indirect connection means. In addition, the term “signal” may refer to at least one current, voltage, charge, temperature, data, electromagnetic wave, or any other one or more signals.

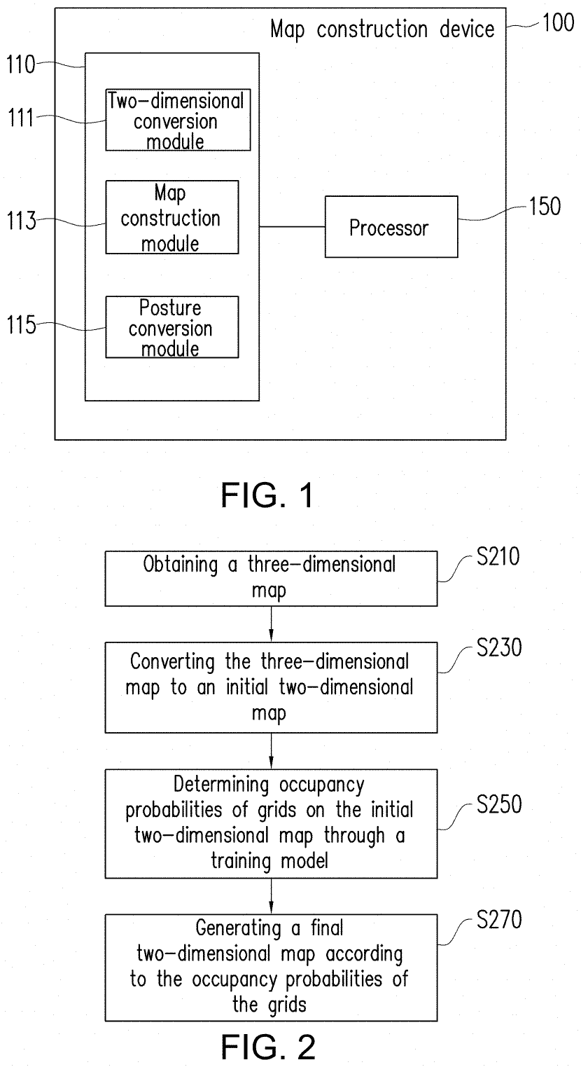

FIG. 1 is an element block diagram of a map construction device 100 according to an embodiment of the disclosure. Referring to FIG. 1, a map construction device 100 includes, but is not limited to, a memory 110 and a processor 150. The map construction device 100 may be, for example, a desktop computer, a notebook computer, an AIO computer, an intelligent mobile phone, a tablet computer, or a server. In some embodiments, the map construction device 100 may be further integrated in an unmanned carrier or a three-dimensional scanning device.

The memory 110 may be any type of fixed or movable random access memory (RAM), read-only memory (ROM), flash memory, traditional hard disk drive (HDD), solid-state drive (SSD), or similar elements. In an embodiment, the memory 110 is configured to record program codes, software modules (such as a two-dimensional conversion module 111, a map construction module 113, and a posture conversion module 115), configuration, data or files (such as depth data, two-dimensional map, training model, training data, three-dimensional map or the like), which will be detailed in subsequent embodiments.

The processor 150 is coupled to the memory 110, and the processor 150 may be a central processing unit (CPU), a graphic processing unit (GPU), or other similar elements such as a programmable general-purpose or special-purpose microprocessors, digital signal processor (DSP), programmable controller, field programmable gate array (FPGA), application-specific integrated circuit (ASIC), neural network accelerator, or a combination of the above elements. In an embodiment, the processor 150 is configured to perform all or part of the operations of the map construction device 100, and may load and perform each software module, file, and data recorded in the memory 110.

In order to facilitate the understanding of the operation flow of the disclosure, a number of embodiments will be given below to illustrate in detail the operation flow of the map construction device 100 in the disclosure. Hereinafter, each device, and its element or module thereof in the map construction device 100 will be used to illustrate the method described in the embodiments of the disclosure.

FIG. 2 is a flow chart of a map construction method according to an embodiment of the disclosure. Referring to FIG. 2, the two-dimensional conversion module 111 obtains a three-dimensional map (step S210). Specifically, the three-dimensional map is constructed based on depth data generated by scanning an architectural space. For example, the two-dimensional conversion module 111 may scan the architectural space (such as building, room, or office of a factory) through an external or a built-in depth sensor, infrared rangefinder, time of flight (ToF) camera, LiDAR sensor, ultrasonic sensor, radar or related distance sensor (hereinafter collectively referred to as distance sensing device), so as to obtain, within its scan range, the depth or distance data of an external object (or obstacles). The three-dimensional map may be a three-dimensional point cloud, grid, or other maps in a similar three-dimensional format. Taking a point cloud image as an example, the distance sensing device may map pixels/blocks to a blank three-dimensional space coordinate according to the depth data corresponding to each pixel/block in sensing data (such as a scene image). After all the pixels/blocks are mapped, a three-dimensional scene point cloud (i.e. three-dimensional map) is generated. Each point in the original three-dimensional scene point cloud includes three-dimensional location in the architectural space and the reflection amount of an object surface; that is, geometric data of the object and the environment can be retained.

The two-dimensional conversion module 111 may convert the three-dimensional map to an initial two-dimensional map (step S230). In an embodiment, the distance sensing device may generate the three-dimensional map based on the navigation technology of simultaneous localization and map construction (SLAM), and no magnetic strips, reflectors, two-dimensional bar codes, or laying rails are required in the process. Instead, spatial scan point localization is adopted.

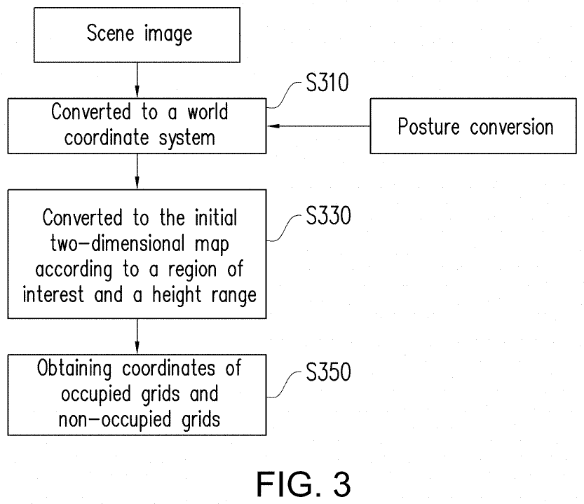

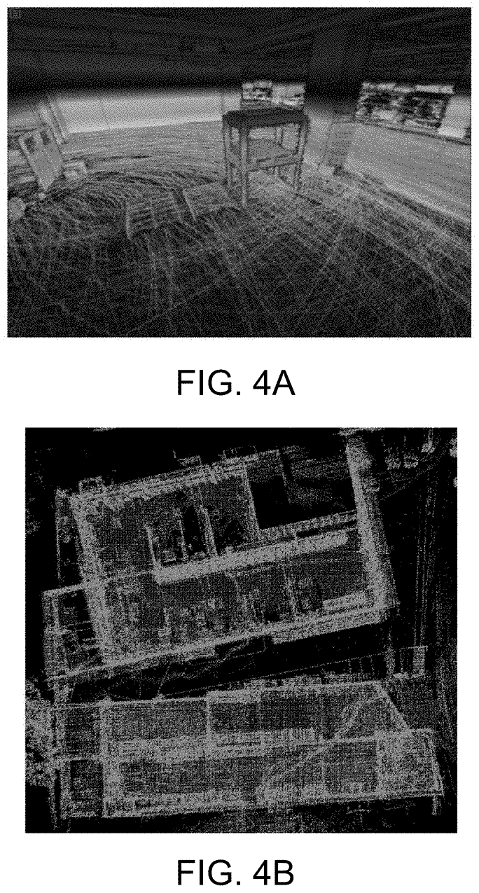

Specifically, FIG. 3 is a flow chart of map conversion according to an embodiment of the disclosure. Referring to FIG. 3, the three-dimensional map includes multiple scene images generated when the distance sensing device scans the architectural space each time, and each scene image records depth data currently captured (i.e. relative distance with the external object). For example, FIG. 4A is an example illustrating a three-dimensional map obtained by a distance sensing device, and FIG. 4B is another example illustrating a three-dimensional map obtained by a distance sensing device. Please refer to FIG. 4A and FIG. 4B, which take the point cloud diagram as an example, in which prototype of the object can be observed.

The two-dimensional conversion module 111 may convert the scene images to a world coordinate system (step S310) according the posture data in the distance sensing device corresponding to the scene images. Specifically, each scene image is scanned by the distance sensing device at a specific location and specific posture (recorded as the posture data). The two-dimensional conversion module 111 obtains the image/frame scanned at each time, and convert each scene image in the three-dimensional map to the world coordinate system according to the posture data corresponding to the distance sensing device. The world coordinate system is a three-dimensional coordinate system formed at scanning the architectural space.

The two-dimensional conversion module 111 may convert the scene images located in the world coordinate system to an initial two-dimensional map according to a region of interest and a height range (step S330). Specifically, the region of interest is a target region pre-defined or defined afterwards in the map, and may be changed according to actual situation. The height range corresponds to the height of the distance sensing device. For example, the height range is roughly a range one meter above and two meters below the unmanned vehicle loaded with the distance sensing device. In some embodiments, the height range is related to the height of movable carriers or men who subsequently use the two-dimensional map for navigation. The two-dimensional conversion module 111 may extract a three-dimensional map of a specific height range based on the world coordinate system, and convert or project the same to a two-dimensional map (or a planar map).

In an embodiment, the two-dimensional conversion module 111 may divide the initial two-dimensional map into multiple grids, and obtain the coordinates of occupied grids and non-occupied grids (step S350). Specifically, there are mainly three types of maps used in indoor navigation: metric map, topological map and occupancy grid map. (1) The metric map directly expresses the location relationship of the locations or objects in the two-dimensional map with precise values. For example, in the two-dimensional map, the points are represented by latitude and longitude. (2) The topological map has a graph structure, in which locations or important locations are represented by nodes, and there is a connection relationship with edges between nodes. The topology map may be extracted through related algorithms through other map types such as metric maps. (3) The occupancy grid map is the most commonly used representation method for unmanned vehicles and robots' recognition towards the environment.

The two-dimensional conversion module 111 presents the initial two-dimensional map in the format of the occupancy grid map. Multiple regions formed by dividing the environment in the occupancy grid map may be referred to as grids, and each grid marks a probability of being occupied by an object (or obstacle) (hereinafter referred to as occupancy probability, which is related to whether there is an object occupying the grid or the possibility of being occupied by an object). The occupancy grid map is often presented as a grayscale image, where the pixel is the grid. The pixels in the grayscale image may be all-black, all-white or gray. An all-black pixel indicates that its probability of being occupied by an object at a corresponding location (i.e. occupancy probability) is relatively large (assuming the occupancy probability is 0 to 1, and the occupancy probability of the all-black pixel is, for example, greater than 0.8 or 0.85). The all-white pixel indicates a region that movable carriers or men may pass through, and the occupancy probability at a corresponding location is small (for example, the occupancy probability of the all-white pixel is less than 0.6 or 0.65). The gray pixel represents a region where the architectural space has not been explored, and its probability of being occupied by an object is between a lower limit of a corresponding probability value of a all-black pixel and an upper limit of the corresponding probability value of a all-white pixel (for example, the occupancy probability of a gray pixel is 0.65 or 0.6).

The map construction module 113 may determine the occupancy probabilities of the grids on the initial two-dimensional map through a training model (step S250). Specifically, the existing technology that only projects the three-dimensional point cloud map to a two-dimensional plane faces many challenges: (1) The plan map after direct projection has data with sparse points, which is not only different from traditional images, but also impossible to clearly show a full picture of target objects such as the environment and the obstacle; (2) The point cloud data is rather unevenly distributed, in which the number of point clouds close to the distance sensing device are much more than the number of point clouds far away; (3) By the direct projection method, noise and unimportant point data cannot be removed, and target obstacles (for example, pallets and shelves) may have fewer point clouds. For the part of all of aforementioned technology problems or other technology problems, in the disclosure embodiment, machine learning algorithm may be adopted to generate a two-dimensional occupancy grid map so as to reduce noise and unimportant point data, thereby improving the distinction between real target obstacles (such as pallets, shelves, walls or the like).

The machine learning algorithm may take unsupervised learning method, such as using convolutional neural network (CNN), AutoEncoder (for example, variational Bayesian convolutional auto-encoder), or using recursive neural network (RNN) (i.e. the neural network for depth learning), multi-layer perceptron (MLP), support vector machine (SVM) or other algorithms. The machine learning algorithm analyzes a training sample and obtains a regulation, thereby predicting unknown data through the regulation. The training model is a machine learning model constructed after learning (corresponding to the regulation), and predicts the data accordingly.

In an embodiment, based on the scene images obtained when the distance sensing device scans each time, the map construction module 113 may construct a multi-layer occupancy grid map as an input for the neural network. The multi-layer occupancy grid map data also contains three features: detections, transmissions, and intensity, which are used for ground segmentation calculation and the train neural network to generate a global occupancy grid map. The training process is the calculation process of generating the map for each scene image, and there is no need to adopt map measurement training of the scene (i.e. unsupervised learning, without using pre-trained ground truth). In the training process of the training model, the map construction module 113 may input the initial two-dimensional map of the image/frame scanned at each time, exact the coordinates of the occupied grips and the non-occupied grids of the image/frame scanned at each time as the training data, and then train the network (i.e. train the model) to learn to distinguish whether or not the current grid is an occupied grid, and the predictive result is represented by the occupancy probabilities. In some embodiments, the model training process may be added to the global two-dimensional map of the scene so as to help the training operation.

In some embodiments, neural network operations may be implemented in PyTorch or other machine learning libraries, and the neural network model parameters may be optimized with Adam optimizer or other learning optimizer. The map construction module 113 may implement the learning rate decay to dynamically adjust and reduce the learning rate of the network training during the process. At the beginning of training, a larger learning rate is adopted first, and the learning rate is gradually decreased as training times increase. Further, the processor 150 may use GPU or other neural network accelerators to accelerate operations. The architecture of the neural network may be composed of 6 layers or more other fully-connected layers, the number of each output channel may be, for example, 64, 512, 512, 256, 128, and 1, respectively, and then the occupancy probability is calculated through activation function (For example, sigmoid, ReLU or TanH).

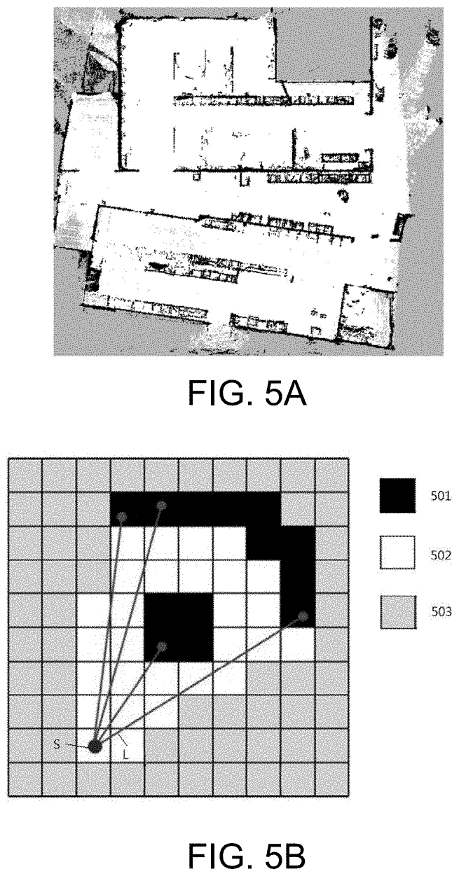

In an embodiment, according to the initial two-dimensional map that has been input, the map construction module 113 may extract the coordinates of the occupied grids (i.e. the grids occupied by objects) and the non-occupied grids (i.e. the grids not occupied by objects). For example, FIG. 5A is an example illustrating an initial two-dimensional map. Referring to FIG. 5A, it is assumed that the current initial two-dimensional map is only converted from the three-dimensional map. FIG. 5B is an example illustrating a schematic diagram of scanning obstacles. Referring to FIG. 5B, in the scanning process, a distance sensing device S emits a scanning light L from where it itself is located each time. When the light L hits the object in the architectural space, a grid 501 of a corresponding coordinate is indicated in black. When the light L passes through a miss area, a grid 502 is indicated in white. Moreover, a grid 503 indicated in gray represents a region that has not been scanned by the light L. Further, the coordinate of the occupied grid refers to the coordinate corresponding to the location of the grid 501, and the coordinate of the non-occupied grid refers to the coordinate corresponding to the location of the grid 502. After multiple scans, the grid of each location is continuously updated to indicate the occupancy probability of the object: p(mi|z1:ₜ,x₁:ₜ), where mᵢ represents the i-th grid on the map, z₁:ₜ represents a measured value from time 1 to ₜ (ₜ is a positive integer), and x₁:ₜ represents the posture data of the distance sensing device from time 1 to ₜ.

The map construction module 113 may generate a final two-dimensional map according to the occupancy probabilities of the grids (step S270). Specifically, the final two-dimensional map is divided according to the grids (i.e. in the form of occupancy grid map), and the grids on the final two-dimensional map are determined whether there are objects occupying thereon according to the corresponding occupancy probability.

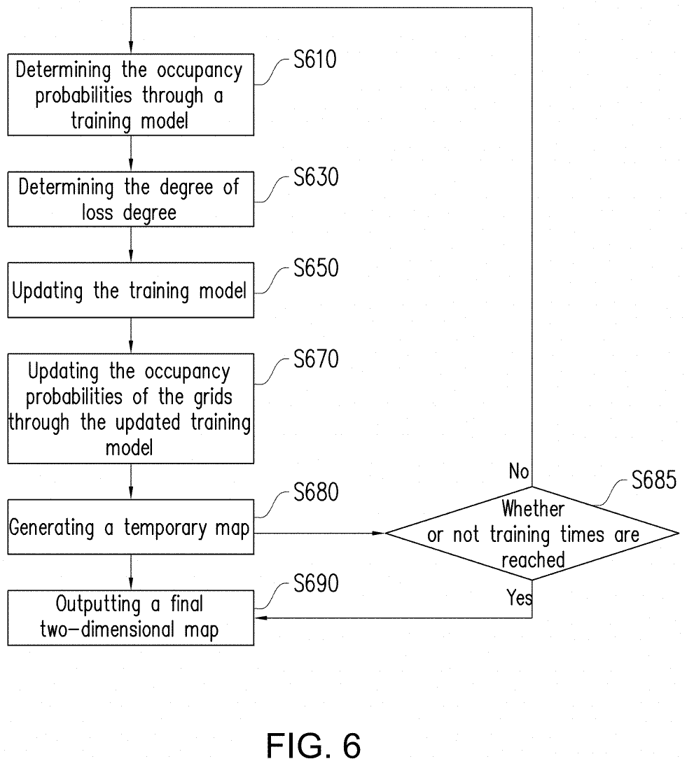

FIG. 6 is a flow chart of generating a final two-dimensional map according to an embodiment of the disclosure. Referring to FIG. 6, the map construction module 113 may predict whether each grid on the initial two-dimensional map is occupied by inferring from the coordinates of the occupied grids and the non-occupied grids of the initial two-dimensional map through the training model, and then determine the occupancy probabilities (step S610). The occupancy probability treats it as binary classification.

The map construction module 113 may determine the degree of loss degree of the predictive result based on binary classification (step S630). Specifically, the binary classification is related to two categories: object occupation and no object occupation. The predictive result is related to the occupancy probabilities of the grids initially inferred through the training model. The degree of loss is related to a difference between the predictive result and a corresponding actual result. For example, the difference between the occupancy probabilities of the predictive result and the actual result.

In an embodiment, in the binary classification, the loss function that map construction module 113 may use is binary cross entropy (BCE), so as to determine the degree of loss. That is, the map construction module 113 calculates the binary cross entropy between a target output (i.e. the actual result) and a predictive output (i.e. the predictive result).

However, in the map, the number of non-occupied grids is often much more than the number of the occupied grids, which causes the problem of class imbalance. In another embodiment, the map construction module 113 may determine the degree of loss through a binary focal loss function (step S630). The binary focal loss function is based on the coordinates of multiple occupied grids and multiple non-occupied grids in the multiples grids. The binary focal loss function is defined as follows:

FL(p,y)=−y(1−p)^{γ} log(p)−(1−y)(p)^{γ} log(1−p) (1)

FL is the binary focal loss function, y is the actual result, p is the occupancy probability output by the training model, and γ stands for weight. The loss function L of a neural network m_{Θ} used to train the model of the embodiment of the disclosure may be defined as:

$$L = \frac{1}{K} {\sum }_{i = 1}^{K} FL [ {m}_{θ} , ( {G}_{i} ) , 1 ] + FL [ {m}_{θ} ( s ( {G}_{i} ) ) , 0 ] \qquad ( 2 )$$

Equation (2) represents calculating the average binary focal loss (K is a positive integer) of all grid/point locations in the two-dimensional maps of all K frames, where Gᵢ stands for the occupied grid in which a K-th frame two-dimensional map in terms of location in world coordinate system is input, and, and s(Gᵢ), stands for the non-occupied grid which extracts a location point from a straight line distance between the occupied grid and the distance sensing device. Reducing the weight of well-classified examples helps the training model to focus on learning the data that are harder to classify (hard examples), that is, the training model focuses on classifying the obstacle area (i.e. occupying the grid).

It should be noted that in some embodiments, the loss function may also be weighted binary cross entropy, balanced cross entropy, mean-square error (MSE), average absolute value error (MAE), or other functions. Furthermore, not limited to training models, in some embodiments, the map construction module 113 may also use binary Bayes filter algorithm to calculate the occupancy probability of each grid.

The map construction module 113 may update the training model according to the degree of loss (step S650). Specifically, the map construction module 113 may compare the degree of loss with a default loss threshold. If the degree of loss does not exceed the loss threshold, the training model may remain unchanged or does not need to be retrained. If the degree of loss exceeds the loss threshold, it may be necessary to retrain or modify the training model. The map construction module 113 may update a parameter of the training model via backpropagation. The parameter is, for example, the weight parameter in the neural network.

The map construction module 113 may update the occupancy probabilities of the grids through the updated training model (step S670). The updated training model of has taken into account the degree of loss between the predictive result and the actual result. In some cases, the updated occupancy probability should be closer to the occupancy probability corresponding to the non-occupied grid or the occupied grid than the previous predictive result. For example, the occupancy probability is a value between 0 and 1, where with update, the occupancy probability is closer to 1 (corresponding to the occupied grid), or the occupancy probability is closer to 0 (corresponding to the non-occupied grid). In addition, the map construction module 113 may generate a temporary map based on the updated occupancy probabilities (step S680). That is, each grid in the temporary map determines whether it itself is an occupied grid, a non-occupied grid, or an unscanned grid based on the updated occupancy probability.

The map construction module 113 may recursively update the training model. Each time the training model is updated, the map construction module 113 may accumulate training times. The map construction module 113 may determine whether the accumulated training times reach predetermined training times (step S685), and terminate updating the training model according to the training times. Specifically, if the accumulated training times have not reached the predetermined training times, the map construction module 113 determines the occupancy probability through the training model again (return to step S610). If the accumulated training times have reached the predetermined training times, the map construction module 113 terminates updating the training model and outputs the final two-dimensional map (step S690). Similarly, the final two-dimensional map is also divided into multiple grids, and the grids may be as shown in the grayscale map of FIG. 5A. The all-black grid 501 indicates the occupied grid (i.e. the occupancy probability of the grid matches the occupancy probability of the occupied grid, having, for example, occupancy probability greater than 0.85 or 0.8). The all-white grid 502 indicates the non-occupied grid (i.e. the occupancy probability of the grid matches the probability of the unoccupied grid, having, for example, occupancy probability less than 0.65 or 0.5). The gray grid 503 indicates the unscanned grid (i.e. the occupancy probability of the grid matches the probability of the unscanned grid, having, for example, occupancy probability approximately 0.65 or 6). In some embodiments, the grid is not limited to being indicated by black, white and gray as mentioned above, and the visual presentation may be changed according to actual needs.

In addition to generating the aforementioned global two-dimensional map with occupancy grids by using the depth learning optimization, in the embodiment of the disclosure, object identification may be performed on the scene images. It is worth noting that automatically guided vehicles (such as forklifts lifting products) need to know the warehousing location, but there are many types of shelf shapes. A lot of data must be trained in advance if a smooth location identification is to be achieved. In order for effective identification and accurate localization, the embodiments of the disclosure can be combined with object identification. The object identification function not only includes distinguishing from the three-dimensional map which points or pixels are occupied by objects (such as pallets, shelves, walls and the like), but also outputs the representative location and orientation of the object, and updates the final two-dimensional map accordingly.

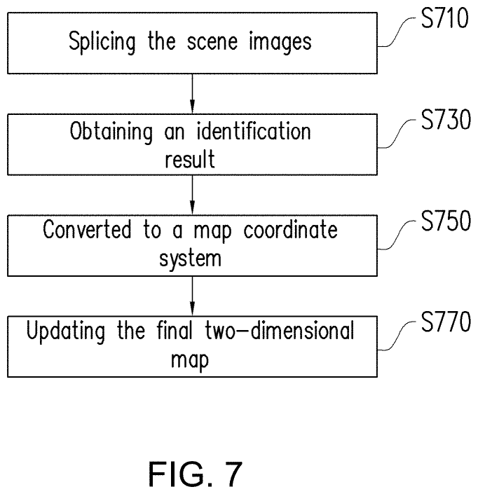

Specifically, FIG. 7 is a flow chart of updating a map based on object identification according to the disclosure-embodiment. Referring to FIG. 7, similarly, the three-dimensional map may include multiple scene images generated by scanning the architectural space each time, and each scene image records the distance or depth data currently captured. The posture conversion module 115 may splice the scene images to generate a scene collection (step S710). Taking a point cloud image as an example, the scene collection is a collection of point cloud images generated by the distance sensing device at each scan. The splicing method may combine the scene collections according to the posture data of the distance sensing device.

The posture conversion module 115 may obtain a predictive result of the object identification from the scene collection (step S730). It is worth noting that, unlike the pixel in the image whose order implies spatial structure, the scene collection's disordered data structure will cause difficulty in constructing the training model. In an embodiment, the posture conversion module 115 may extract multiple image features. For example, PointNet proposes to use a symmetric function (such as max pooling) to extract features to solve the disorder, and the extracted features are global features. The posture conversion module 115 may adopt PointNet++ if local features are to be extracted. However, for the point cloud structure of the object without outstanding or deformed shapes, using global features should be sufficient. The posture conversion module 115 may extract point image features through the PointNet architecture for subsequent object identification. The posture conversion module 115 may collect two-dimensional images of some default objects in advance as training data for supervised learning. The posture conversion module 115 may perform training and identification through Open3D or other databases, output point-level segmentation results, and then collect and segment adjacent semantic point clouds into semantic objects. The posture conversion module 115 may identify the default objects in the scene collection (such as pallets, shelves, walls or the like) according to the image features. That is, if the segmented semantic object matches the default object, it may be regarded as having identified the default object. Also, if the segmented semantic object does not match the default object, it may be regarded as not having identified the default object.

It should be noted that the learning architecture of feature extraction is not limited to the aforementioned PointNet and PointNet++, and may be changed to other architectures based on actual needs.

The posture conversion module 115 may compare the identified default object with a reference object, and determine the location and orientation of the default object based on the comparison result. Specifically, the posture conversion module 115 may match the semantic object and the reference object (i.e. a standard object with defined location and orientation), and then covert a representative location (such as the location of its center, profile, or corners) and orientation of the reference object to the semantic object having identified the default object, and finally output the location and orientation of the identified default object (i.e. the identification result, which is related to the posture).

It should be noted that in some embodiments, the posture conversion module 115 may additionally generate a second training model and directly predicts the location and orientation of the default object in the scene collection.

The posture conversion module 115 may convert the identification result corresponding to the default object to the map coordinate system (step S750). The map coordinate system is the coordinate system used in the aforementioned final two-dimensional map. The posture conversion module 115 may update the final two-dimensional map according to the identified location and orientation of the default object (step S770). For example, the posture conversion module 115 may mark the identified default object mark on the final two-dimensional map according to the identification result of the posture.

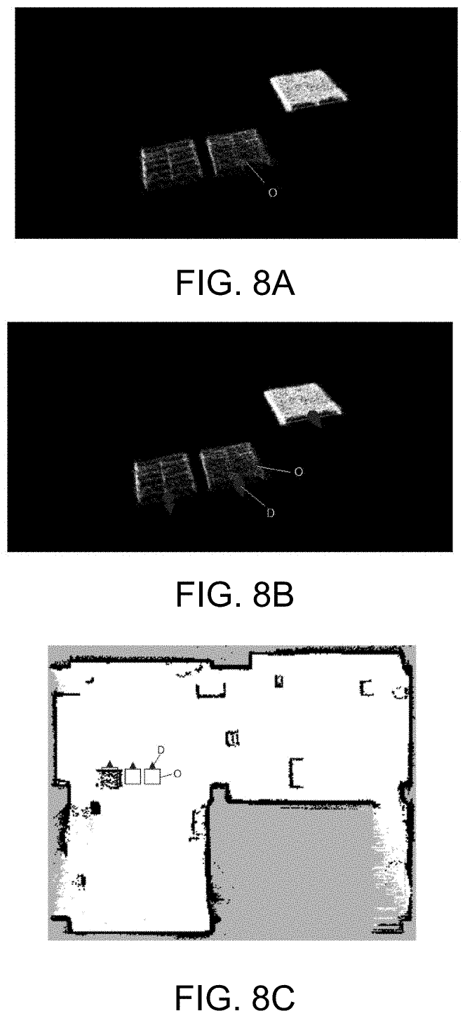

FIG. 8A is an example illustrating segmenting an image of an object. Referring to FIG. 8A, the posture conversion module 115 may identify that the presence of a default object O in the scene collection (taking the pallet as an example). FIG. 8B is an example illustrating identifying an object and the orientation thereof. Referring to FIG. 8B, the posture conversion module 115 may further determine the representative location and an orientation D of the default object O. FIG. 8C is an example illustrating an updated final two-dimensional map. Referring to FIG. 8C, the default object O is marked on the final two-dimensional map according to the orientation D of the determiner.

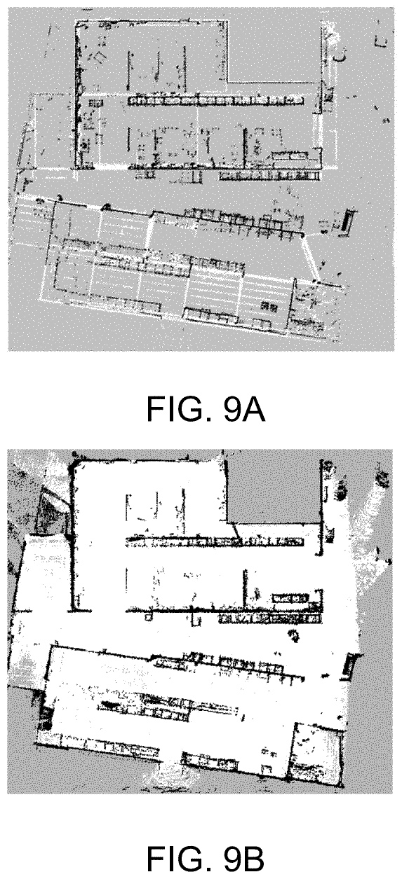

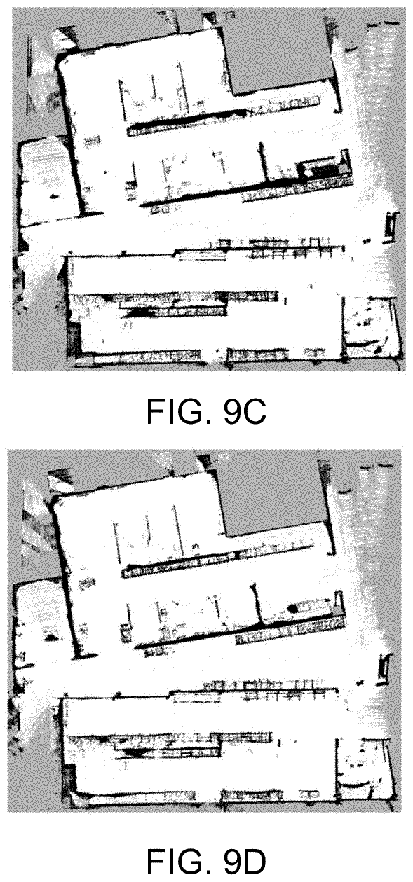

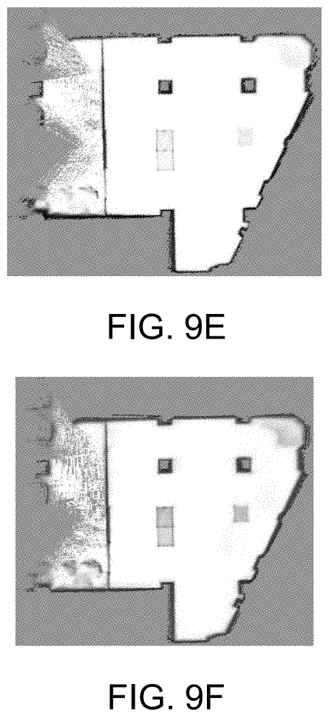

To help readers understand the effect of the embodiments of the disclosure, a few examples are given below, without the intention to impose limits to the embodiments of the disclosure. FIG. 9A is an example illustration a planar point cloud diagram by an unmanned vehicle with height direct projection, and FIG. 9B is an example illustrating a final two-dimensional map generated according to an embodiment of the disclosure. Referring to FIG. 9A and FIG. 9B, in comparison, lot of noise and unimportant point data are reduced in FIG. 9A, and the structure of the map scene is retained.

FIG. 9C is an example illustrating the final two-dimensional map generated by taking a frame of the point cloud image scanned at each time as the training data, and FIG. 9D is an example illustrating a final two-dimensional map generated by taking a frame of point cloud image and global point cloud image scanned at each time as training data. Referring to FIG. 9C and FIG. 9D, in comparison, the boundary and details around the scene in FIG. 9D are more complete.

FIG. 9E is an example of a final two-dimensional map generated based on a binary cross entropy loss, and FIG. 9F is an example of a final two-dimensional map generated based on a binary focal loss. Referring to FIG. 9E and FIG. 9F, in comparison, the profile of some of the obstacles in FIG. 9F is clearer. For example, the data for the original point cloud in FIG. 9E, such as pallet and shelves, is less.

To sum up, in the map construction device and method thereof of the embodiments of the disclosure, the training model may be used to determine the occupied grid and the non-occupied grid, to improve the predictive result based on the binary classification, and to indicate the location and orientation of the default object by combining object identification. Thereby, the noise of the point cloud collected by the three-dimensional sensing device can be avoided, and the generated map is relatively free of noise. The model training process of generating the map is the calculation process of constructing the map, and there is no need to use map measurement and map ground truth of the training scene. The three-dimensional point cloud is converted to a planar point cloud based on the posture data, more point clouds may be extracted from the region of interest, without having to calculate regions outside the map, thereby usage of memory and cost for computing time of the computing device can be reduced. Furthermore, identifying the orientation of the object through the point cloud and marking the default object location in the navigation map can be useful for subsequent warehouse management navigation applications.

The above-mentioned content is only the preferred embodiment of the disclosure, and should not be used to limit the scope of implementation of the disclosure; that is, all simple equivalent changes and modifications made in accordance with the claims of the disclosure and the content of the specification still fall within the scope covered by the patent of the disclosure. Any embodiment or claim of the disclosure does not have to achieve all the objectives or advantages or features disclosed in the disclosure. Moreover, the abstract and title are only used to assist in searching for patents, and are not intended to limit the scope of the disclosure. Furthermore, the terms “first” and “second” mentioned in the claims are only used to name the elements or to distinguish different embodiments or ranges, and not to limit the upper or lower limit of the number of elements.

The foregoing description of the exemplary embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the disclosure” or the like does not necessarily limit the claim scope to a specific embodiment, and the reference to particularly exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A map construction method, comprising:
obtaining a three-dimensional map, wherein the three-dimensional map is constructed based on depth data generated by scanning an architectural space;
converting the three-dimensional map to an initial two-dimensional map, wherein the initial two-dimensional map is divided into a plurality of grids;
determining occupancy probabilities of the plurality of grids on the initial two-dimensional map through a training model, wherein the occupancy probability of each of the plurality of grids is related to whether there is an object occupying thereon; and
generating a final two-dimensional map according to the occupancy probabilities of the plurality of grids, wherein the final two-dimensional map is divided according to the plurality of grids, and the plurality of grids on the final two-dimensional map are determined whether there are objects occupying thereon.

2. The map construction method according to claim 1, wherein a step of determining the occupancy probabilities of the plurality of grids on the initial two-dimensional map through the training model comprises:
determining, based on a binary classification, a degree of loss of a predictive result, wherein the binary classification is related to object occupation or no object occupation, the predictive result is related to the occupancy probabilities of the plurality of grids, and the degree of loss is related to a difference between the predictive result and a corresponding actual result; and
updating the training model according to the degree of loss.

3. The map construction method according to claim 2, wherein a step of determining the degree of loss of the predictive result comprises:
determining the degree of loss through a binary focal loss function, wherein the binary focal loss function is based on coordinates of a plurality of occupied grids and a plurality of non-occupied grids in the plurality of grids, each of the plurality of occupied grids is a grid with object occupation, and each of the plurality of non-occupied grids is a grid with no object occupation.

4. The map construction method according to claim 2, wherein a step of determining the occupancy probabilities of the plurality of grids on the initial two-dimensional map by the training model comprises:
updating the occupancy probabilities of the plurality of grids through the updated training model; and
recursively updating the training model and terminating updating the training model according to training times.

5. The map construction method according to claim 1, wherein the three-dimensional map comprises a plurality of scene images generated by scanning the architectural space each time, wherein each of the plurality of scene images records depth data currently captured, and a step of converting the three-dimensional map to the initial two-dimensional map comprises:
respectively converting the plurality of scene images to a world coordinate system according to posture data by a distance sensing device mapped from each of the plurality of scene images; and
converting the plurality of scene images located in the world coordinate system to the initial two-dimensional map according to a region of interest and a height range, wherein the height range corresponds to a height of the distance sensing device.

6. The map construction method according to claim 1, wherein the three-dimensional map comprises a plurality of scene images generated by scanning the architectural space each time, wherein each of the plurality of scene images records depth data currently captured, and the map construction method further comprises:
splicing the plurality of scene images so as to generate a scene collection;
extracting a plurality of image features from the scene collection; and
identifying a default object in the scene collection according to the plurality of image features.

7. The map construction method according to claim 6, further comprising after identifying the default object in the scene collection:
comparing the default object with a reference object; and
determining a location and an orientation of the default object based on a comparison result.

8. The map construction method according to claim 7, wherein a step of generating the final two-dimensional map according to the occupancy probabilities of the plurality of grids comprises:
updating the final two-dimensional map according to the location and the orientation of the default object, wherein the default object is converted to a map coordinate system and marked on the final two-dimensional map.

9. A map construction device, comprising a memory and a processor, wherein
the memory stores a plurality of software modules; and
the processor is coupled to the memory, and loads and performs the plurality of software modules, wherein the plurality of software modules comprise a two-dimensional conversion module and a map construction module, wherein
the two-dimensional conversion module obtains a three-dimensional map and converts the three-dimensional map to an initial two-dimensional map, the three-dimensional map is constructed based on depth data generated by scanning an architectural space, and the initial two-dimensional map is divided into a plurality of grids; and
the map construction module determines occupancy probabilities of the plurality of grids on the initial two-dimensional map through a training model, and generates the final two-dimensional map according to the occupancy probabilities of the plurality of grids, wherein the occupancy probability of each of the plurality of grids is related to whether there is an object occupying thereon, the training model is constructed based on a machine learning algorithm, the final two-dimensional map is divided according to the plurality of grids, and the plurality of grids on the final two-dimensional map are determined whether there are objects occupying thereon.

10. The map construction device according to claim 9, wherein the map construction module determines a degree of loss of a predictive result based on a binary classification, and the map construction module updates the training model according to the degree of loss, wherein the binary classification is related to object occupation and no object occupation, the predictive result is related to the occupancy probabilities of the plurality of grids, and the degree of loss is related to a difference between the predictive result and a corresponding actual result.

11. The map construction device according to claim 10, wherein the map construction module determines the degree of loss through a binary focal loss function, wherein the binary focal loss function is based on coordinates of a plurality of occupied grids and a plurality of non-occupied grids in the plurality of grids, each of the plurality of occupied grids is a grid with object occupation, and each of the plurality of non-occupied grids is a grid with no object occupation.

12. The map construction device according to claim 10, wherein the map construction module determines the occupancy probabilities of the plurality of grids through the updated training model, and the map construction module recursively updates the training model and terminates updating the training model based on training times.

13. The map construction device according to claim 9, wherein the three-dimensional map comprises a plurality of scene images generated by scanning the architectural space each time, each of the plurality of scene images records depth data currently captured, the two-dimensional conversion module converts the plurality of scene images to a world coordinate system according to posture data by a distance sensing device mapped from each of the plurality of scene image, and the two-dimensional conversion module converts the plurality of scene images located in the world coordinate system to the initial two-dimensional map according to a region of interest and a height range, wherein the height range corresponds to a height of the distance sensing device.

14. The map construction device according to claim 9, wherein the plurality of software modules comprise:
a posture conversion module, splicing the plurality of scene images so as to generate a scene collection, extracting a plurality of image features from the scene collection, and identifying a default object in the scene collection according to the plurality of image features.

15. The map construction device according to claim 14, wherein the posture conversion module compares the default object with a reference object, and the posture conversion module determines a location and an orientation of the default object according to a comparison result.

16. The map construction device according to claim 15, wherein the posture conversion module updates the final two-dimensional map according to the location and the orientation of the default object, wherein the default object is converted to a map coordinate system and marked on the final two-dimensional map.
